(19) United States
(12) Patent Application Publication
(10) Pub. No.: US 2016/0125358 A1
(43) Pub. Date: May 5, 2016

(54) PLATFORM FOR DELIVERY OF POST ITEMS GENERATED FROM DIGITAL ITEMS

(71) Applicant: Pixinote, Inc., Larkspur, CA (US)

(72) Inventors: Daniel Kushner, San Rafael, CA (US); Travis Parker, Larkspur, CA (US)

(21) Appl. No.: 14/929,205

(22) Filed: Oct. 30, 2015

Related U.S. Application Data
(60) Provisional application No. 62/072,902, filed on Oct. 30, 2014.

(51) Int. Cl. G06Q 10/08; G06K 15/00; G06K 15/02; G06F 17/30

(52) U.S. Cl. CPC G06Q 10/0835; G06F 17/30241; G06K 15/4005; G06K 15/02

(57) ABSTRACT

A system and a related method for managing mappings between user handles and physical addresses are disclosed. In some embodiments, the system allows a user to provide a user handle and a physical address. The system maps user handles to physical addresses for users. Furthermore, the system offers standard digital templates for short items. A user can prepare digital items based on one of the templates and request delivery to a recipient identified by a user handle. In response, the system generates a physical item according to the filled-out template and mails the item to the recipient at the physical address according to the mapping. The system also allows a user to request delivery of a physical item to a recipient identified by a user handle and rely on a party involved in packaging or delivering the physical item to resolve the user handle into a physical address according to the mapping.

### RELATED APPLICATIONS

The present application claims priority to and benefit from U.S. Provisional Patent Application 62/072,902, filed Oct. 30, 2014 and titled “PLATFORM FOR DELIVERY OF POST ITEMS GENERATED FROM DIGITAL ITEMS”. The entire content of the provisional application is herein expressly incorporated by reference.

### TECHNICAL FIELD

The present application is related to converting digital items to post items, and, in particular, the preparation of digital items and delivery of post items.

### BACKGROUND

For a long period of time, people communicated solely through physical media. Today, people mainly communicate electronically, via email, websites, social media, etc. In the online world, people can communicate at or near real time even if they reside in different physical locations. They are often represented by simple identities and aliases instead of their real names, physical address, or other details relevant in the physical world. Therefore, users can freely communicate online without knowing anything about one another in the physical world.

Electronic communication, including the representation by simple identities and aliases, often has the advantages of organization, efficiency, privacy, or convenience. However, receiving and viewing postal mail continues to retain certain appeal.

### BRIEF DESCRIPTION OF THE DRAWINGS

Various embodiments are disclosed in the following detailed description and accompanying drawings.

FIG. 1 illustrates an example screen that serves as an entry point into a system disclosed in the present application.

FIGS. 2A-2C illustrates example screens for creating an account.

FIG. 3 illustrates an example screen that displays an initial page to a user upon signing in.

FIG. 4 illustrates an example screen for managing a list of user IDs associated with a user's account.

FIGS. 5A-5F illustrate example screens for adding an entry to a list of user IDs associated with a user's account.

FIG. 6 illustrates an example screen for editing a list of user IDs associated with a user's account.

FIG. 7A illustrates an example screen for creating a digital item based on a standard template.

FIG. 7B illustrates an example screen for filling out a graphics area of a standard template.

FIG. 7C illustrates an example for filling out a three-line text area of a standard template.

FIG. 7D illustrates an example screen for displaying a filled-out template.

FIGS. 8A-8C illustrate example screens for sending a post item corresponding to a digital item and a receipt.

FIG. 9 illustrates an example screen for creating a new digital item based on an existing one.

FIG. 10 illustrates a process performed by the system for converting a digital item to a post item.

FIG. 11 illustrates a process performed by a user of the system of handling delivery of physical packages.

FIG. 12 is a high-level block diagram showing an example architecture of a computer, which may represent any electronic device, any server, or any node within a cloud service as described herein.

### DETAILED DESCRIPTION

This application is related to a system and related methods that enable a user to send physical items to a physical location of another user while limiting communication to the online world. The system is capable of converting digital items to post items and managing mappings between user handles and physical addresses. In some embodiments, the system includes a server component and a client component. The server component can include one or more processors and databases that can manage user handles, physical addresses, mappings between user handles and physical addresses, digital templates, etc. The client component can be any computing device, such as a desktop computer, a tablet, a laptop, a mobile phone, or a wearable device, that is capable of managing a user interface for registering with the system, managing contact lists, managing digital templates, preparing digital items, and performing other tasks. Specifically, the client component can have capabilities for sound recording and touch sensing and capturing. In some embodiments, the server component and the client component can communicate through any type of network known to someone of ordinary skill in the art, such as the Internet, a cellular network, or a short-range communication network. The client component can communicate with a user through a graphical user interface. In addition, various devices can also communicate with the system through an application programming interface (API). To ensure a high level of security especially for the mapping between user handles and physical addresses, the system can adopt rigorous security measures on user authentication, user access control, data transfer across networks, data storage, and so on using techniques known to someone of ordinary skill in the art.

In some embodiments, the system allows a user to register, select a user handle, and provide physical addresses. The system maps registered user handles to physical addresses for registered users, including mapping multiple user handles to the same physical address or the same user handle to multiple physical addresses. Furthermore, the system offers standard digital templates for short items. For example, a template can accommodate an image and a few short lines and be readily converted into a postcard. The system can also allow the user to create custom templates. A user can prepare digital items based on one of the templates and request delivery to one or more user handles. The user can also prepare digital items based on existing digital items. In response to receiving a digital item, the system generates a physical or post item, which can indicate the user's user handle, and sends the post item to a physical address corresponding to a designated user handle according to the mapping. The physical item and the accompanying envelope are designed for easy manufacturing and automatic processing with minimal changes to existing machinery, easy opening by the recipient, and clear branding on the standard envelope. The system can also allow the user to associate a video or additional multimedia content with the digital item and the recipient to view the associated content separately online.

By automatically generating a physical item from a digital item, the system allows a user to send post items with the same ease as sending digital items. By managing the mapping between user handles and physical addresses, the system allows a user to send post items to recipients by simply referring to their user handles even though the user may not have any knowledge of the recipients' physical addresses. This feature saves a user from memorizing or mistyping a recipient's physical address. It also enables a recipient to change the recipient's physical address while continuing to receive post items without having to inform other users of the change. It also offers a level of physical isolation and protection to users. In addition, the system allows a user to send post items under the user's handle without revealing the user's physical address. This feature can be useful when anonymity is desired.

In some embodiments, not only end users but merchants and carriers (or delivery service providers in general) can utilize the services provided by the system. It is thus possible to simplify the communication for various parties involved in the packaging and delivery of a physical item. A customer placing an order from a merchant is allowed to provide to the merchant only the user handle of the recipient who is a user of the system. The merchant can indicate the provided user handle on the package for the order, in which case the carrier of the package can convert the user handle to a physical address, as discussed below. If the merchant is an administrator of the system or otherwise has legitimate access to the mapping managed by the system, the merchant can convert the user handle to a physical address and put the physical address on the package. To be an administrator or obtain legitimate access, the merchant may be required to satisfy certain conditions, such as verifying that it is operating a legitimate business. Alternatively, a customer who has purchased an item in the store can directly write only the recipient's user handle on the package of the item. In addition to a physical address, the system can also provide the merchant with the corresponding postage or other data that facilitates the delivery.

In some embodiments, a carrier can similarly be an administrator or otherwise have legitimate access to the mapping managed by the system. To be an administrator or obtain legitimate access, the carrier similarly may be required to satisfy certain conditions for authentication or other purposes. In either case, the carrier can convert a user handle on a package to a physical address to get the package ready for delivery. To keep the connection between the user handle and the physical address hidden to the public, the carrier can completely replace the user handle on the package with the converted physical address before delivery. In addition to a physical address, the system can also provide the carrier with the corresponding directions or other data that facilitates the delivery.

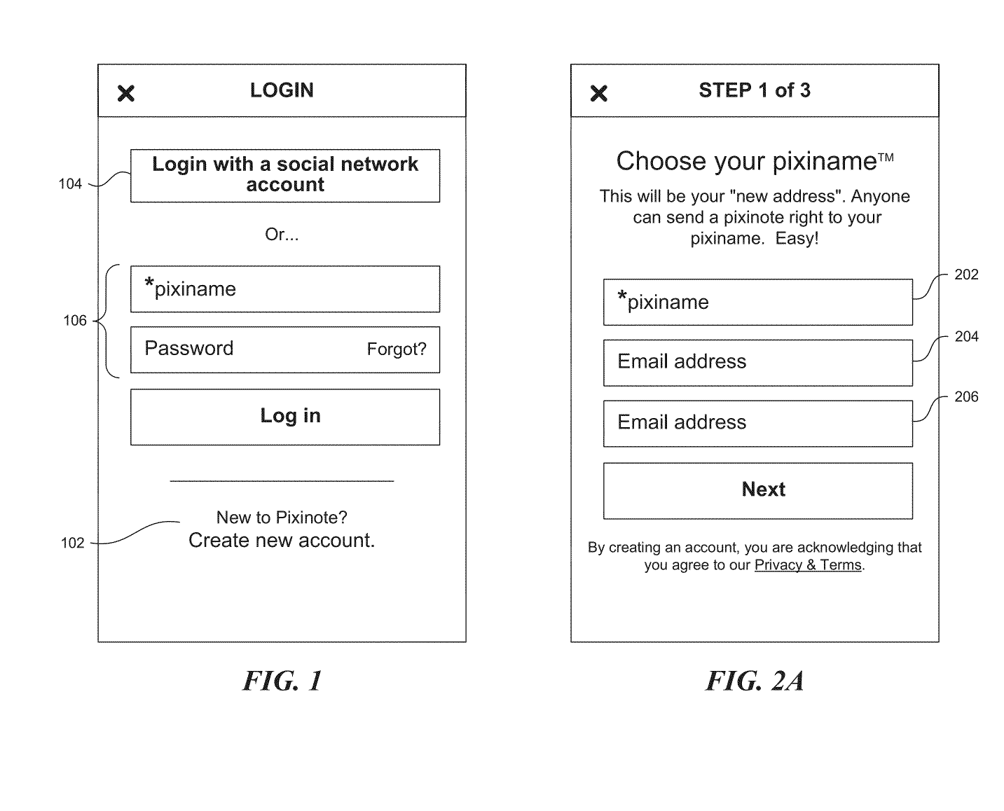

In some embodiments, the client component manages a graphical user interface (“GUI”) having various screens. FIG. 1 illustrates an example screen that serves as an entry point into the system. In some embodiments, a user can create an account through the create option 102. After an account is created, the user can log into the account by entering the user's credentials in the provided text fields 106. The system can also be integrated with other online systems, such as a social network. This feature allows the user to log in to the system through an existing account with another online system, which in turn allows the system to have access to information associated with that existing account. Therefore, the user can log in by choosing the integrated login option 104.

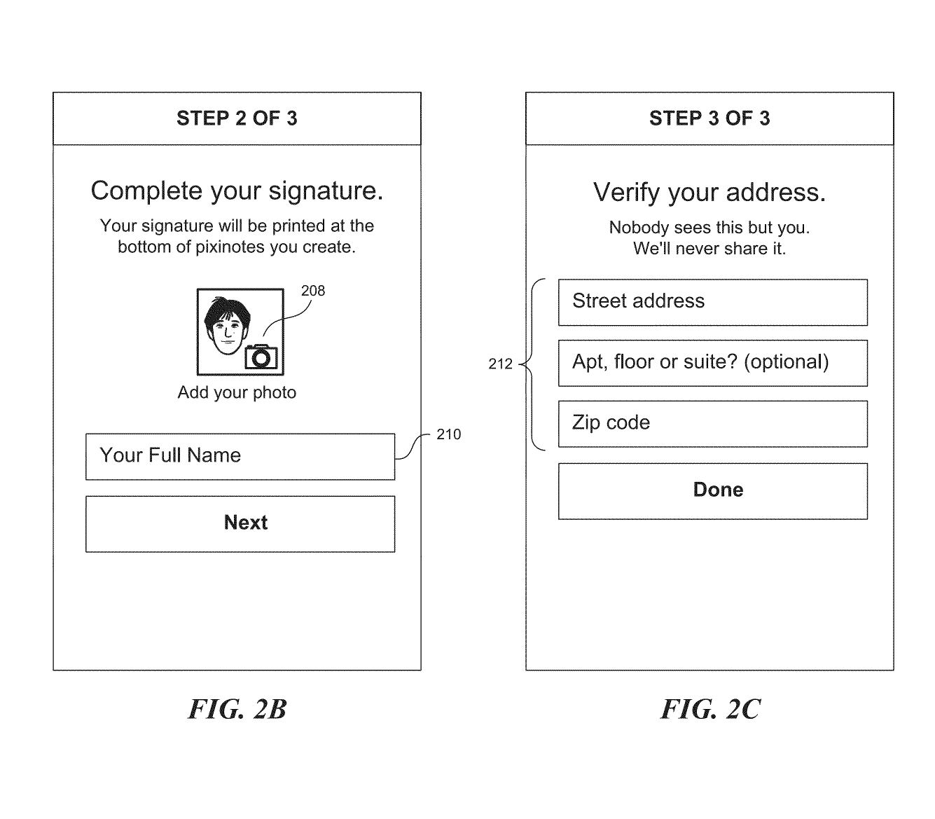

FIGS. 2A-2C illustrate example screens for creating an account. In some embodiments, the user can enter a user-selected user ID or user handle (pixiname) into the field 202, provide basic user information, typically including a name and an email address, through the fields 204 and 210, and enter a user-selected password into the field 206. In addition, the user can select a photo for the account from a local repository on the client device through the option 208. The user can also take a selfie and directly associate the photo with the account. Furthermore, the user can provide a physical address for the account through the field 212. The system can also allow the user to provide additional physical addresses and specify one as a default.

In some embodiments, the system can require authentication of user information. For example, the system may send a brief, sample post item to the email address provided by the user and ask the recipient to confirm the creation of the account. The system can also match the name and physical address provided by the user and verify it with public databases, such as one provided by the postal service. Upon successful authentication, the system can allow the user to set various privacy options regarding whether a piece of information associated with the account is searchable and to which other users or under what circumstances the piece of information would be searchable. For example, a privacy option can specify that the user ID is searchable to all the users who belong to a predefined group or a user-defined group. Another privacy option can specify that the mapping between the user ID and the physical address is accessible only to specified carriers but not to merchants. Yet another privacy option can specify that the photo can be shown only on items to be delivered to specific geographic regions.

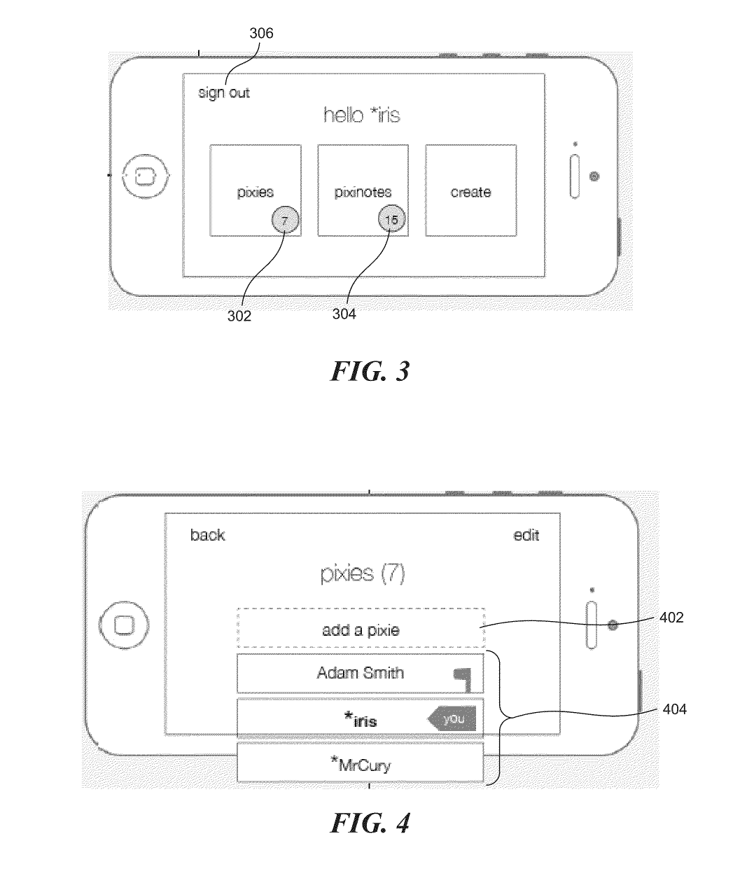

FIG. 3 illustrates an example screen that displays an initial page to a user upon signing in. In some embodiments, the screen can display the number of user IDs (pixies) of other users associated with the user's account in the area 302 and the number of digital items (pixinotes) associated with the user's account in the area 304. The user can also choose to sign out of the system through the “sign out” option 306.

FIG. 4 illustrates an example screen for managing the list of user IDs associated with a user's account. The list contains user IDs of other users with whom the user might wish to correspond and will be referred to as a “community list” hereinafter. In some embodiments, the system allows the user to add a user ID to the community list through the option 402 so that the user can send an item to the user represented by the user ID. The user can also view the user IDs already on the community list in the area 404 and make changes to the community list, by selecting one of those user IDs, for example.

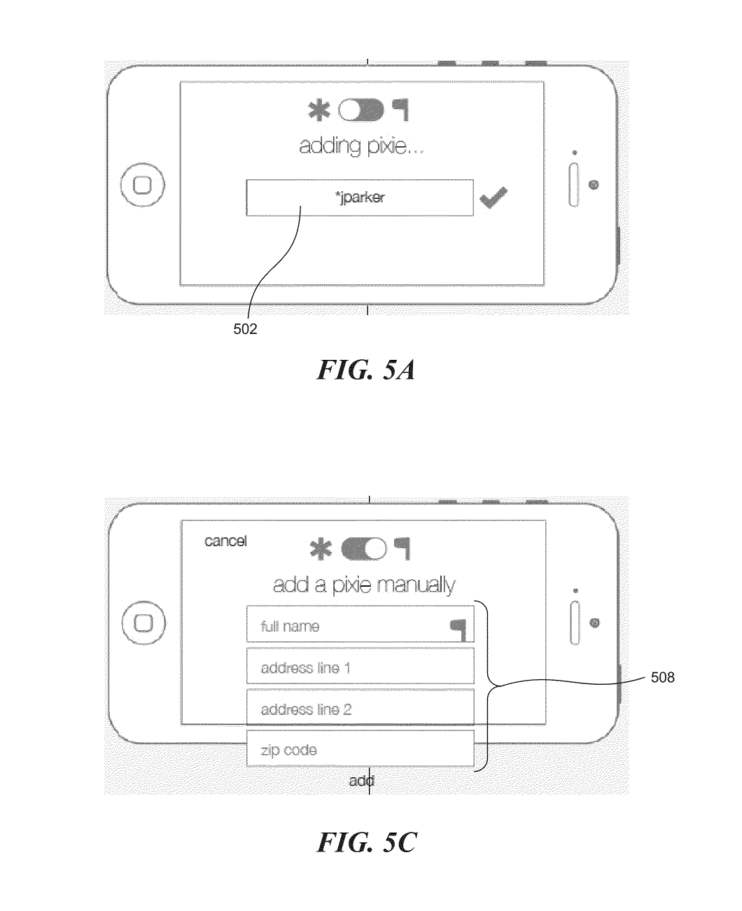

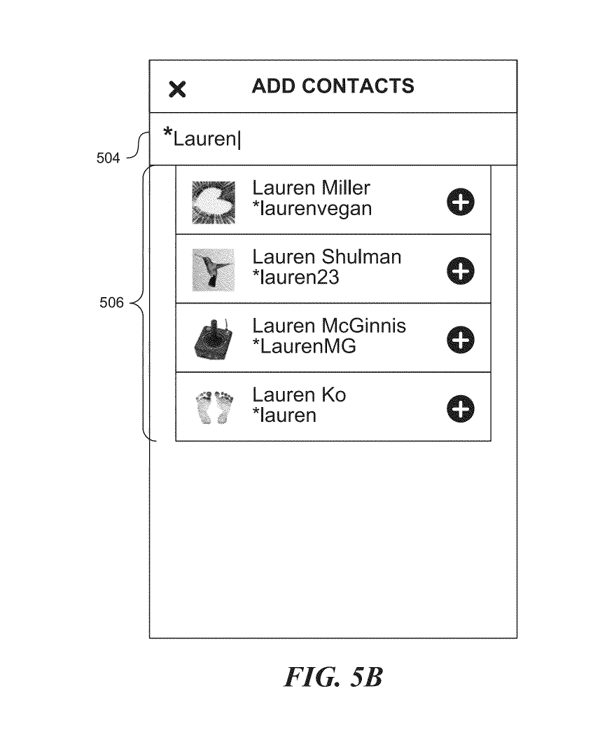

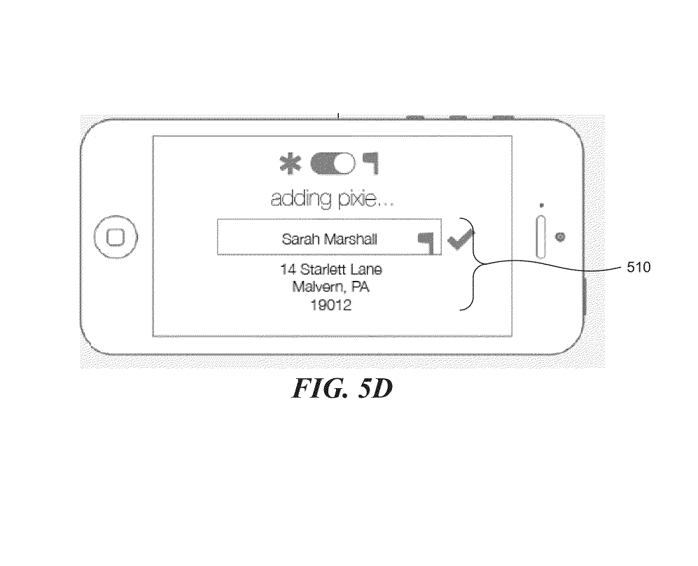

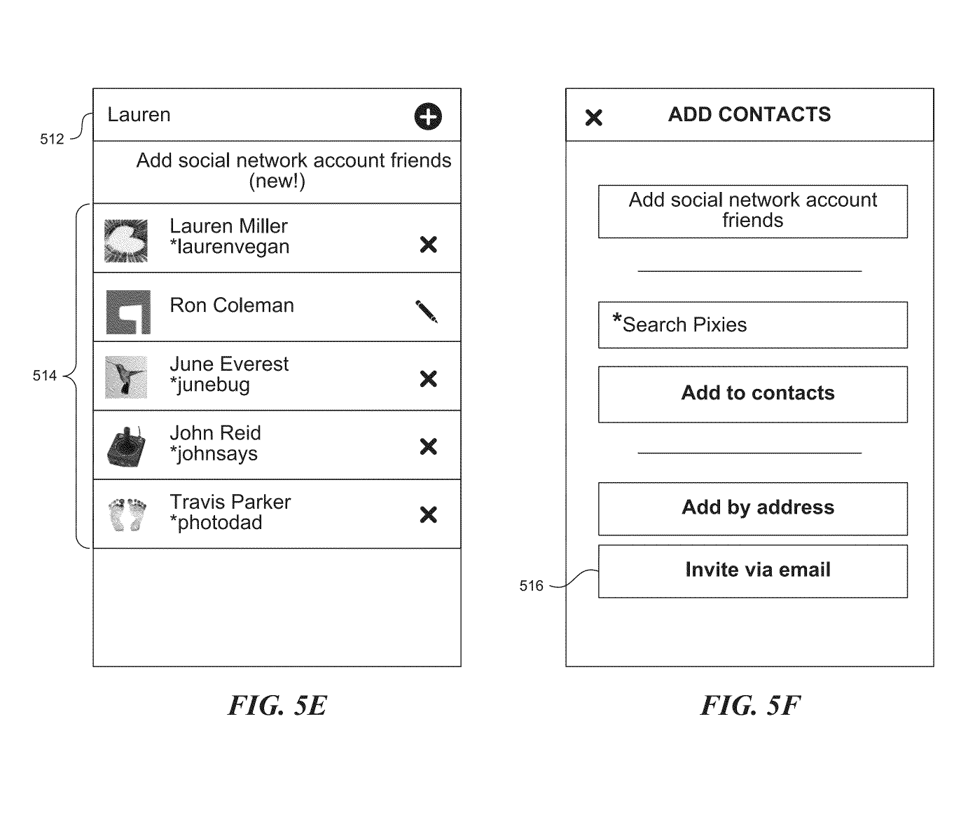

FIGS. 5A-5F illustrate example screens for adding an entry to a list of user IDs associated with a user's account. In some embodiments, as illustrated in FIG. 5A, the user can enter a known user ID of another user in the field 502. The system can then send a notification to this other user and only add the known user ID to the community list if the other user agrees to the addition to the community list and the receipt of a post item from this user. Similarly, as illustrated in FIG. 5B, the user can first identify a user ID of another user by entering a partial user ID of that other user in the field 504. The system in response displays a certain list of searchable user IDs 506 that match the partial user ID, from which the user can select the correct one. As illustrated in FIG. 5C, the user can first identify a user ID of another user by entering that other user's basic information in the area 508. For example, that other user can be a friend of the user and thus has already provided the user with part or all of his or her address. The system can then contact an address database, such as one provided by the postal service, to complete a partial address or verify a complete address. For example, upon receiving a name, a street address, and a zip code from the user, the system may retrieve the corresponding city and state from the address database, thereby also verifying the information provided by the user. In response, as illustrated in FIG. 5D, when the system successfully verifies an address, it shows the full entry, including the complete, verified, and standardized address, in the area 510; otherwise, the system can display an error message for failing to complete a partial address, verify a complete address, etc.

As illustrated in FIG. 5E, if the user has logged in to the system through an account with a social network, the user can first identify a user ID of another user in the system by searching a group of users associated with that social network account. Specifically, the user can enter a keyword (such as “Lauren”) in the field 512. The system in response displays a specific list of entries 514, each showing a name (such as “Lauren Miller”) of a user in the group of users and the corresponding user ID in the system (such as “laurenvegan”), that match the keyword. The match can be based on data ranging from the user IDs of the users in the group to various types of data in the accounts of the users on the social network. The user can then choose an entry from the special list. Furthermore, as illustrated in FIG. 5F, the system can allow the user to first invite a person to join the system, thereby establishing a new user ID, and then add the new user ID to the community list. For example, if the user knows that person's email address, the user can send that person an invite through the invite option 516.

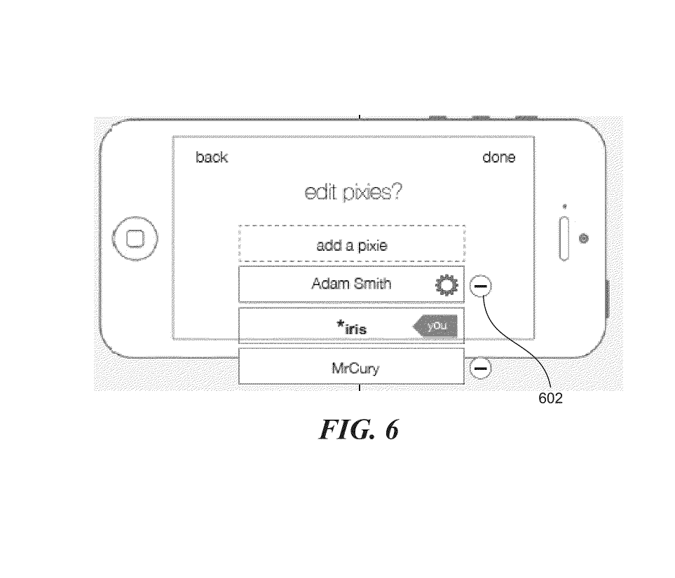

FIG. 6 illustrates an example screen for editing a list of user IDs associated with a user's account. In some embodiments, the system allows the user to delete an entry from the community list by displaying a “delete” option 602 beside each user ID other than the user's own. The user can then delete a user ID on the community list by choosing the associated “delete” option.

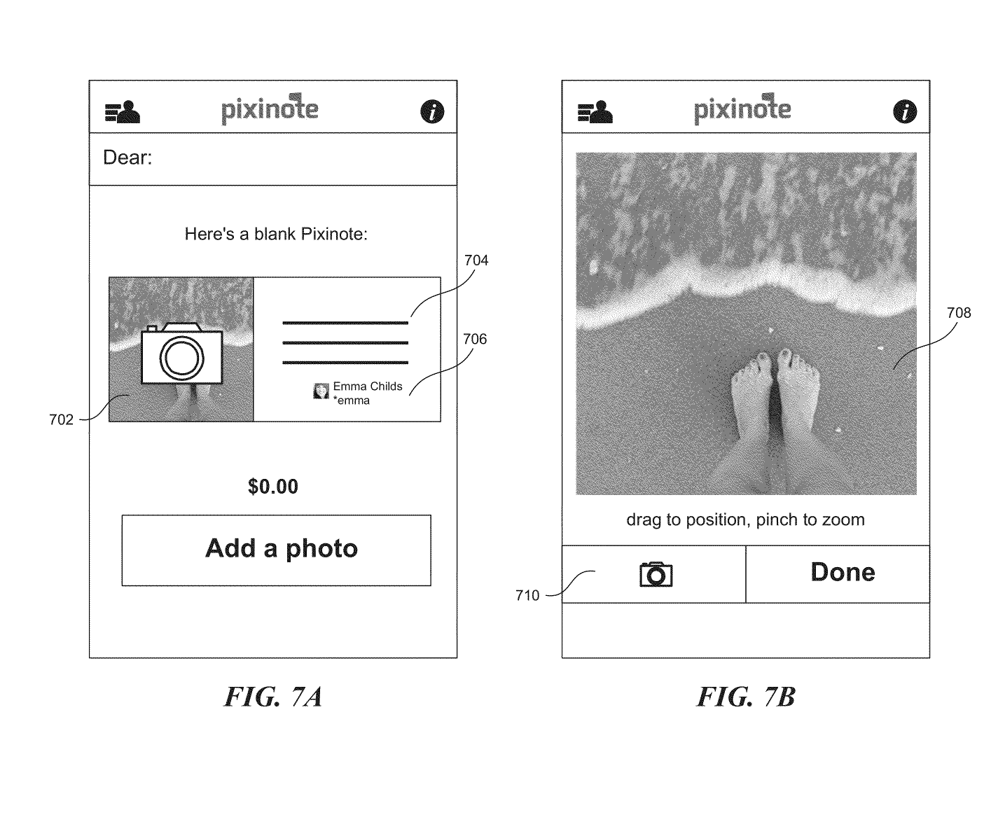

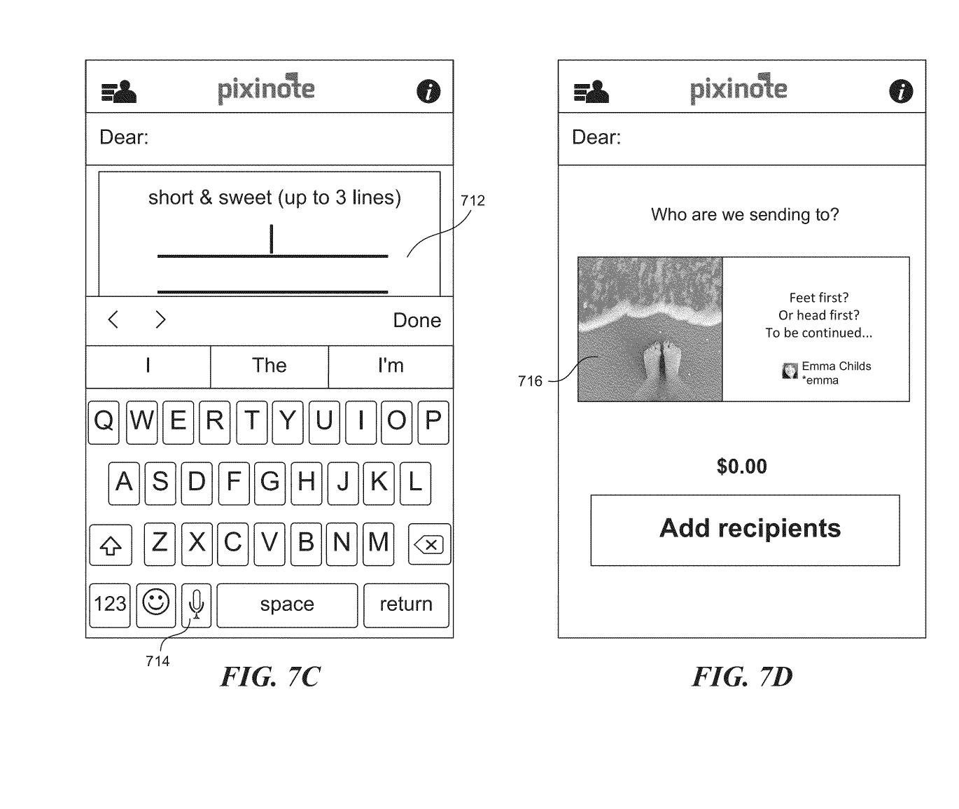

FIG. 7A illustrates an example screen for creating a digital item based on a standard template. In some embodiments, the system shows a template that includes a graphics area 702 and a three-line text area 704, which is ready for conversion into a postcard or other one-page physical media. The template could also include an identification area 706 showing one or more pieces of information regarding the user, such as the user ID, the name, and the photo. The user can fill out the template by filling each of the areas with either an image or lines of text. FIG. 7B illustrates an example screen for filling out the graphics area 702 of a standard template. In some embodiments, the system allows the user to select an existing image through a dialogue or first shoot an image through the camera option 710. The system then displays the selected or created image in a display area 708 and allows the user to drag, zoom, or otherwise manipulate the image before it's incorporated into the graphics area 702. FIG. 7C illustrates an example for filling out the three-line text area 704 of a standard template. In some embodiments, the system displays a virtual keyboard and allows the user to provide text for each of the lines in the area 708. The system can also display options for fonts, sizes, colors, etc. The number of characters or words that can be entered for each line may be limited, and the number of words still allowed can be indicated. In addition, the user can provide each line of text verbally through the record option 714, or through handwriting. FIG. 7D illustrates an example screen for displaying a filled-out template in preparation for setting up the delivery process. In some embodiments, the system shows the filled-out template in a central area 716. The corresponding post item to be delivered to a physical address can be essentially a replica of the filled-out template, and so this screen also serves as a preview of the post item.

In some embodiments, the system offers one or more standard templates for composing items. For example, another template allowing a large number of lines of text might be ready for conversion into a long-form letter instead of a postcard. The system can also allow the user to modify one of the standard templates. For example, for the standard template discussed in connection with FIG. 7A, a user may choose to allocate a larger area to the graphics and a smaller area to the text or provide an image for the background. In addition, the system can maintain a set of rules and permit a user to create new templates subject to these rules. For example, one rule can be that the total amount of text is no more than 50 words, and another rule can be that the overall layout needs to fit into a rectangle of a certain size.

In some embodiments, the system allows users to associate a short video or other multimedia content with the digital item. The user can choose from an existing library of videos in local storage or from a system library, shoot a video and save it locally or store it with the user's account, provide a link to a video on the web, etc. The system can save the video in the user's account, in a central repository, in a recipient's account, etc. The digital item and the corresponding post item can contain a notice of the video, which can contain an instruction of how to access the video. The system can also send a separate electronic notice to the recipient, via an email message sent to an email address of the recipient, a text message sent to a phone number of the recipient, a chat message sent to an account of the recipient with a social network, and so on (when relevant contact information of the recipient is available). The system can allow the recipient to launch or download the video directly from the electronic notice, by first logging into the recipient's account with the system and then accessing it from there, and so on. The system can also require the recipient to authenticate himself or herself or at least show that the recipient has the actual post item before allowing access to the video. As one example, the user may need to first take a photo of the post item or otherwise upload a digital version of the post item. The system can also rely on biometric technology by scanning the recipient's eyes, fingerprints, etc. that have been stored in the recipient's account during registration.

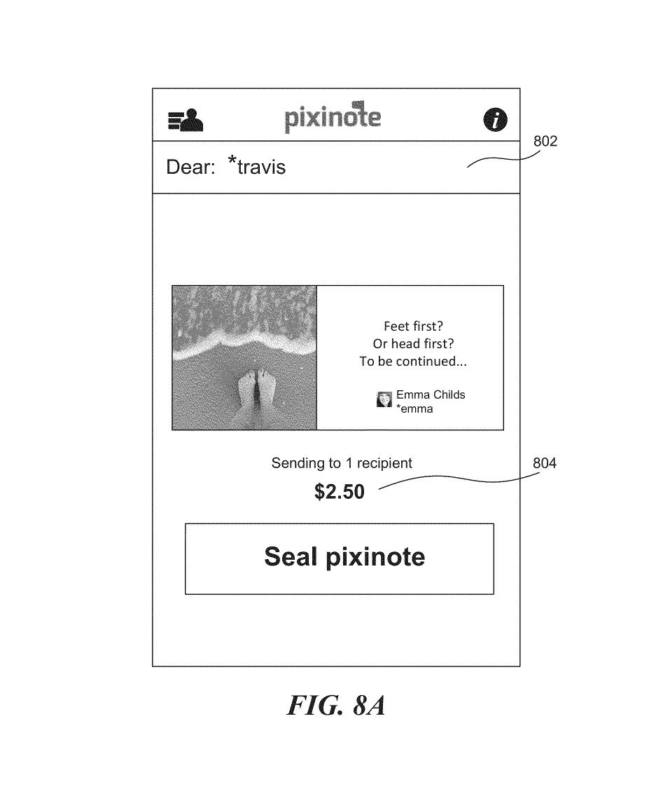

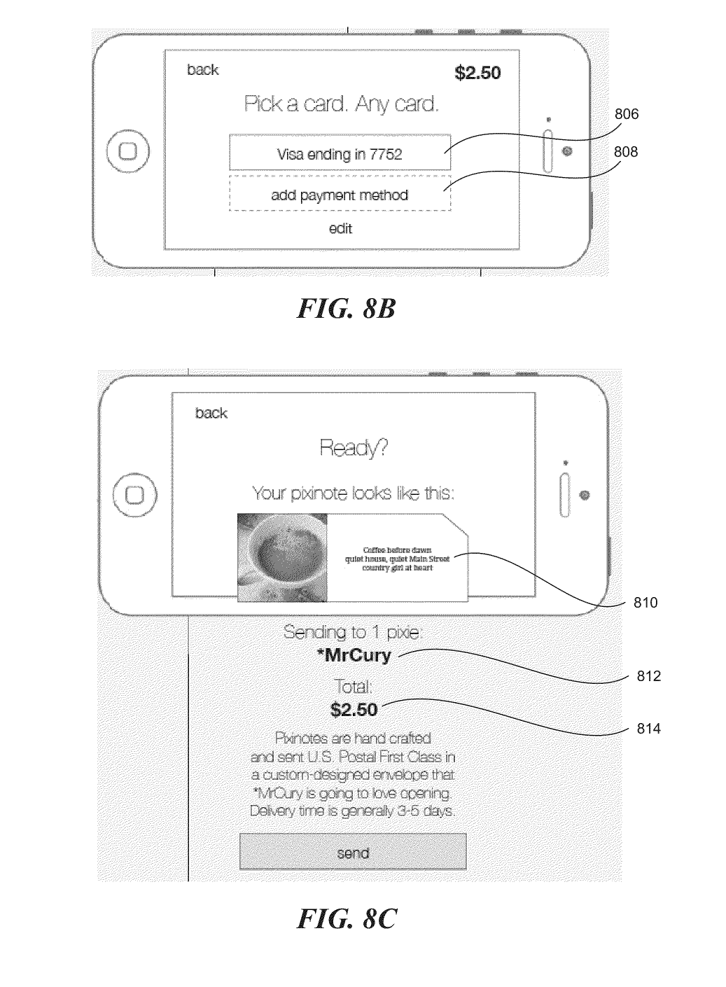

FIGS. 8A-8C illustrate example screens for sending a post item corresponding to a digital item to a recipient. In some embodiments, as illustrated in FIG. 8A, the system allows the user to specify a recipient by the recipient's user ID through the field 802. The system can also allow the user to identify a recipient by first searching the community list of user IDs associated with the user's account or the list of user IDs in the system. The user can repeat such a process to send the digital item to multiple recipients at once. The user can also specify which identification information on the post item is for each of the recipients. For example, the identification information could be one or more pieces of data from the user's account, it could be a one-time code or other information, or it could be empty. In addition, the system indicates the cost in the area 804, such as the cumulative cost of sending the item to all the specified recipients. As illustrated in FIG. 8B, to pay the cost, the user can specify a payment method by selecting an existing credit card in the field 806 or by adding a new payment method in the field 808. Alternatively, the user can pre-select a payment method as the default method, and the system will apply that method automatically. As illustrated in FIG. 8C, before the system completes the transaction and sends a post item to the specified recipients, a screen displays a summary of the transaction, including a preview of the item in the area 810, the list of recipients in the area 812, and the total cost in the area 814.

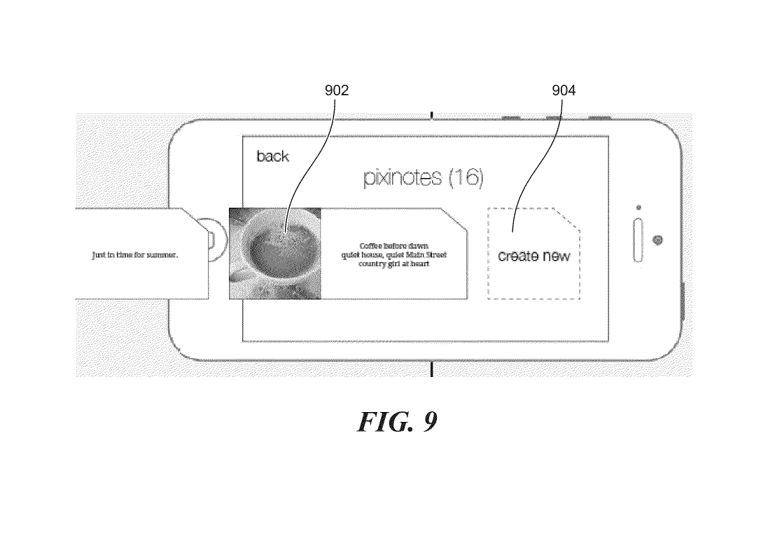

In some embodiments, the system allows a user to manage the digital items associated with the user's account. The system can display a list of previously prepared items, including drafts that have not been sent, a list of previously sent items, and so on. The system can also allow the user to compare different items, create a new item based on an existing item, etc. FIG. 9 illustrates an example screen for creating a new digital item based on an existing one. The system displays an existing digital item, possibly in a condensed form, in the area 902 and allows the user to create a new digital item based on the displayed digital item through the field 904. For example, the system can allow the user to make changes to a duplicate of the displayed digital item. The system can also prepopulate select portions of a new digital item with corresponding portions from the displayed digital item and allow the user to complete the other portions of the new digital item. In addition, the system can also allow the user to drag and drop specific portions of the displayed digital item into a blank digital item.

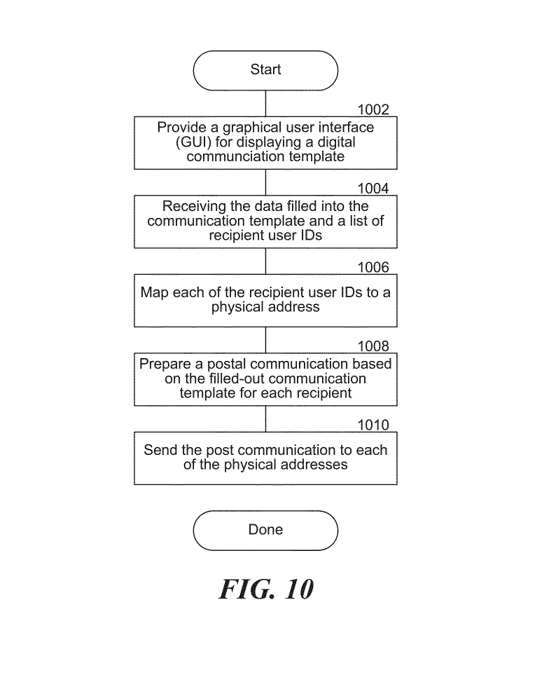

FIG. 10 illustrates a process performed by the system for converting a digital item to a post item. In step 1002, the system provides a GUI that enables a user to create a digital item. The GUI can be transmitted to a client device, such as a tablet or a mobile phone, for display to a user. For example, the system can display a digital item template for the user to fill in. This template can limit the item to include one image and three lines of text, for example, so that the post item would look just like a postcard. The system can also display a filled-out template or another completed digital item and allow the user to create a new one based on the display digital item. In step 1004, the system receives a completed digital item to be converted to a post item, which includes the data that the user provides to fill out a digital item template. It also receives a list of user IDs corresponding to recipients of the complete item. In step 1006, the system maps each of the user IDs to a physical address according to the mapping.

In step 1008, the system prepares a post item according to the filled-out digital item template for every recipient. For example, the system can insert the user's user ID, or the user's real name if the user so desires, into the digital data and convert the digital data into the same postcard for many recipients, or it can insert each recipient's user ID or real name into the digital data and convert the digital data into a customized postcard for each recipient. The system can also print each individual recipient's physical address on a separate envelope that will contain the postcard without also printing the recipient's user ID on the envelope, which reduces the chance of discovering by a third party the mapping between the receipt's user ID and the recipient's physical address. In addition, the system can print the user's user ID or real name on one or more envelopes based on the user's preference. Furthermore, the system can also determine whether a recipient has agreed to receive a post item from this user and will prepare a post item only upon a positive determination. In step 1010, the system sends the prepared post items to the recipients, by the postal service, by a courier, by a drone, etc. Throughout this process, the system can send status update to the user, such as when the physical item is created, dispatched for delivery, and received by the recipient.

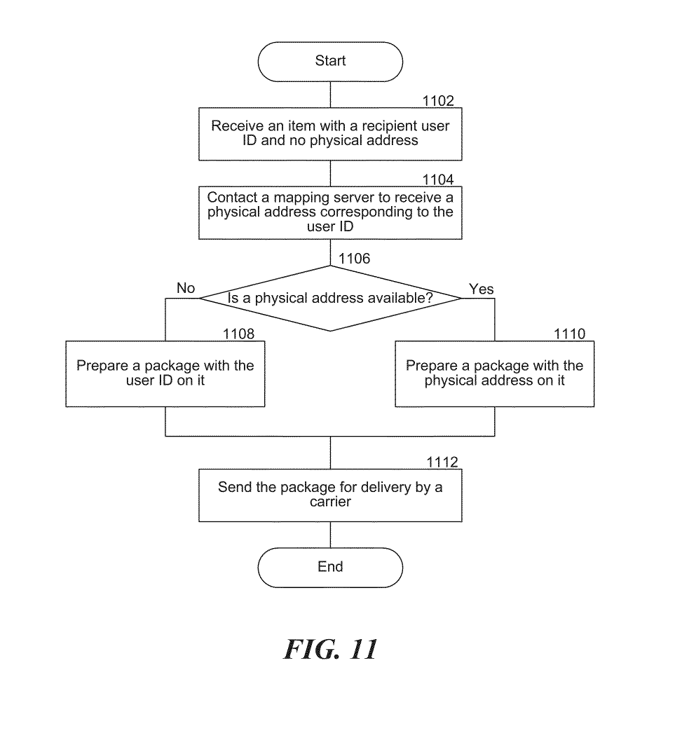

FIG. 11 illustrates a process performed by a client of the system of handling delivery of physical packages. In some embodiments, the client can be a computing server of merchant from which a customer has ordered an item. In step 1102, the merchant server receives the order of an item along with a user ID of the recipient. As the customer has not specified the recipient's physical address, in step 1104, the merchant server contacts the system disclosed in the present application that manages the mapping between user IDs and physical addresses to obtain a corresponding physical address. If the merchant server has administrative privilege in the system or otherwise has legitimate access to the mapping, the merchant server can consult the mapping directly. In step 1106, the merchant server determines whether the physical address is available. It can be unavailable for a variety of reasons, such as a wrong spelling of the user ID, a non-existent user, or insufficient access privilege. When a corresponding physical address is available, in step 1110, the merchant server includes the item in a package and indicates the physical address on the package. When a corresponding physical address is unavailable, in step 1108, the merchant server includes the item in a package and indicates the user ID on the package, leaving the user ID to be resolved into a physical address downstream in the process, such as by a carrier. The system In step 1112, the merchant server then puts the package for delivery by the postal service, by a courier, a carrier, a messenger, a drone, etc. The party responsible for delivering the package can also operate their computing server to convert a user ID to a physical mapping in a similar manner.

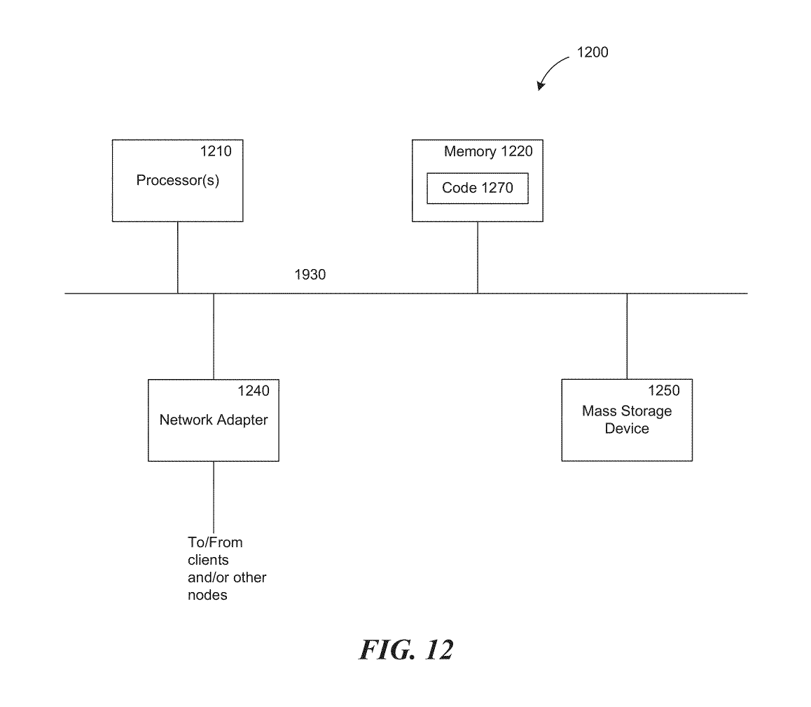

FIG. 12 contains a high-level block diagram showing an example architecture of a computer, which may represent any electronic device, such as a mobile device or a server, including any node within a cloud service as described herein, such as may implement the operations described above. The computer 1200 includes one or more processors 1210 and memory 1220 coupled to an interconnect 1230. The interconnect 1230 shown in FIG. 12 is an abstraction that represents any one or more separate physical buses, point to point connections, or both connected by appropriate bridges, adapters, or controllers. The interconnect 1230, therefore, may include, for example, a system bus, a Peripheral Component Interconnect (“PCI”) bus or PCI-Express bus, a HyperTransport or industry standard architecture (“ISA”) bus, a small computer system interface (“SCSI”) bus, a universal serial bus (“USB”), IIC (“I2C”) bus, or an Institute of Electrical and Electronics Engineers (“IEEE”) standard 1394 bus, also called “Firewire”.

The processor(s) 1210 is/are the central processing unit (“CPU”) of the computer 1200 and, thus, control the overall operation of the computer 1200. In certain embodiments, the processor(s) 1210 accomplish this by executing software or firmware stored in memory 1220. The processor(s) 1210 may be, or may include, one or more programmable general-purpose or special-purpose microprocessors, digital signal processors (“DSPs”), programmable controllers, application specific integrated circuits (“ASICs”), programmable logic devices (“PLDs”), field-programmable gate arrays (“FPGAs”), trusted platform modules (“TPMs”), or a combination of such or similar devices.

The memory 1220 is or includes the main memory of the computer 1200. The memory 1220 represents any form of random access memory (“RAM”), read-only memory (“ROM”), flash memory, or the like, or a combination of such devices. In use, the memory 1220 may contain code 1270 containing instructions according to the techniques disclosed herein.

Also connected to the processor(s) 1210 through the interconnect 1230 are a network adapter 1240 and a mass storage device 1250. The network adapter 1240 provides the computer 1200 with the ability to communicate with remote devices over a network and may be, for example, an Ethernet adapter. The network adapter 1240 may also provide the computer 1200 with the ability to communicate with other computers.

The code 1270 stored in memory 1220 may be implemented as software and/or firmware to program the processor(s) 1210 to carry out actions described above. In certain embodiments, such software or firmware may be initially provided to the computer 1200 by downloading it from a remote system through the computer 1200 (e.g., via network adapter 1240).

### Conclusion

The techniques introduced herein can be implemented by, for example, programmable circuitry (e.g., one or more microprocessors) programmed with software and/or firmware, or entirely in special-purpose hardwired circuitry, or in a combination of such forms. Software or firmware for use in implementing the techniques introduced here may be stored on a machine-readable storage medium and may be executed by one or more general-purpose or special-purpose programmable microprocessors.

In addition to the above mentioned examples, various other modifications and alterations of the invention may be made without departing from the invention. Accordingly, the above disclosure is not to be considered as limiting, and the appended claims are to be interpreted as encompassing the true spirit and the entire scope of the invention.

The various embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatuses, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

I/we claim:

1. A non-transitory computer-readable storage medium whose contents are capable of causing a processor to perform a method that allows users to send physical items through digital user handles, the method comprising:
receiving a delivery request from a sender device of a sender to deliver a physical item to a recipient,
wherein the delivery request includes a sender user ID of the sender, a recipient user ID of the recipient, and information regarding an item;
translating the recipient user ID to a recipient physical address of the recipient based on a mapping,
wherein the mapping regarding the sender is kept confidential unless certain access is allowed by the sender;
identifying the physical item from the information regarding the item; and
generating packaging information for delivering the physical item to the recipient physical address.

2. The storage medium of claim 1, the method further comprising:
receiving a registration request from the sender device to register with the processor before receiving the delivery request,
wherein the registration request includes the sender user ID, a sender physical address of the sender, and access control information regarding the sender user ID and the sender physical address; and
managing the mapping based on the registration request.

3. The storage medium of claim 2, the method further comprising:
receiving a search request from the user device to search for the recipient user ID before receiving the delivery request; and
processing the search request in accordance with access control information regarding the recipient user ID; and
sending the recipient user ID to the sender device.

4. The storage medium of claim 2, wherein the registration request includes information regarding a social network where the sender user ID is already registered.

5. The storage medium of claim 1, wherein the item is the same as the physical item.

6. The storage medium of claim 1, wherein the item is a digital item, and the physical item is a hard copy of the digital item.

7. The storage medium of claim 6, the method further comprising:
receiving a composition request from the sender device to build the digital item before receiving the delivery request;
sending a template to the sender device for building the digital item in response to the composition request; and
receiving the digital item from the sender device.

8. The storage medium of claim 6, wherein the digital item has a fixed format including three lines of text and an image and can be printed on a postcard.

9. The storage medium of claim 1, wherein the translating comprises:
sending a lookup request to a system across a computer network,
wherein the lookup request includes the recipient user ID; and
receiving information including the recipient physical address from the system in response to the lookup request.

10. The storage medium of claim 1,
wherein the delivery request indicates whether to include no information regarding the sender, only the sender user ID, or both the sender user ID and the sender physical address in the packaging information, and
wherein the generating is performed according to the delivery request.

11. The storage medium of claim 1, wherein the sender device is a desktop computer, a laptop computer, a tablet, a cellular phone, or a wearable device.

12. A method performed by a sender device of a sender that allows the sender to send physical items through digital user handles, the method comprising:
receiving, by the sender device, a registration request to register with a server across a computer network,
wherein the registration request includes a sender user ID of the sender and a sender physical address of the sender;
sending, by the sender device, the registration request to the server;
receiving, by the sender device, certain data for building a digital item;
building the digital item;
receiving, by the sender device, a delivery request to send a physical item corresponding to the digital item to a recipient,
wherein the delivery request includes the sender user ID, information identifying the physical item, and a recipient user ID of the recipient, and
wherein the delivery request does not include a recipient physical address of the recipient; and
sending the delivery request to the server.

13. The method of claim 12, wherein the registration request includes access control information regarding the sender user ID and the sender physical address.

14. The method of claim 12, wherein receiving the certain data further comprises:
receiving a selection from one or more templates for building a digital item;
displaying a copy of the selected template; and
receiving data for filling the template,
wherein the filled template forms the digital item.

15. The method of claim 12, wherein receiving the certain data further comprises:
receiving a selection from one or more digital items that were built previously;
displaying a copy of the selected digital item; and
receiving data for updating the copy,
wherein the updated copy forms the digital item.

16. The method of claim 12, wherein the digital item includes a first portion to be converted into the physical item and a second portion to be viewed online.

17. The method of claim 10, wherein the delivery request indicates whether to include the sender user ID or the sender physical address on a package for the physical item to be delivered to the recipient.

18. A system that allows users to send physical items through digital user handles, comprising:
a processor and memory, cooperating to function as:
a receiving unit configured to receive a delivery request from a sender device of a sender to deliver a physical item to a recipient,
wherein the delivery request includes a sender user ID of the sender, a recipient user ID of the recipient, and information regarding an item;
a translating unit configured to translate the recipient user ID to a recipient physical address of the recipient based on a mapping,
wherein the mapping regarding the sender is kept confidential unless certain access is allowed by the sender;
an identifying unit configured to identify the physical item from the information regarding the item; and
a generating unit configured to generate packaging information for delivering the physical item to the recipient physical address.

19. The system of claim 18, the processor and memory further cooperating to function as:
a second receiving unit configured to receive a registration request from the sender device to register with the processor before receiving the delivery request,
wherein the registration request includes the sender user ID, a sender physical address of the sender, and access control information regarding the sender user ID and the sender physical address; and
a managing unit configured to manage the mapping based on the registration request.

20. The system of claim 18,
wherein the delivery request indicates whether to include no information regarding the sender, only the sender user ID, or both the sender user ID and the sender physical address in the packaging information, and
wherein the generating unit generates the packaging information according to the delivery request.
